(19) United States
(12) Patent Application Publication
(10) Pub. No.: US 2003/0214472 A1
(43) Pub. Date: Nov. 20, 2003

(54) Display circuit structure for liquid crystal display

(75) Inventor: Hsin-Ming Chen, Hsinchu (TW)

Correspondence Address: SUGHRUE MION, PLLC, 2100 PENNSYLVANIA AVENUE, N.W., WASHINGTON, DC, 20037, US

(73) Assignee: TOPPOLY OPTOELECTRONICS CORP.

(21) Appl. No.: 10/235,726

(22) Filed: Sep. 6, 2002

(30) Foreign Application Priority Data
May 15, 2002 (TW) 91110181

(51) Int. Cl. G09G 3/36

(52) U.S. Cl. 345/87

(57) ABSTRACT

A scan line is used to control two thin film transistors and a video data line is used to transmit video signal to pixel capacitors and maintenance capacitors. When the thin film transistors are selected by the selection signal, the video signal stored therein charges the pixel capacitors and maintenance capacitors. When the selection signal is removed, the charge in the pixel capacitors is preserved until the next repetition when that scan line is again selected by a selection signal and new voltages are stored therein. Thus a picture is displayed on the matrix display by the charges stored in the pixel capacitors.

### FIELD OF THE INVENTION

The present invention relates to a display circuit structure for a liquid crystal display (LCD), and more particularly to a display circuit structure for a liquid crystal display (LCD) having reflection and transmission regions.

### BACKGROUND OF THE INVENTION

Liquid crystal displays (LCD) have been widely applied in electrical products, such as digital watches, calculator, etc. for a long time. Moreover, with the advance of techniques for manufacture and design, thin film transistor-liquid crystal display (TFT-LCD) has been introduced into portable computers, personal digital assistants, and color televisions, as well as gradually replacing the CRT used for conventional display. The demands of TFT-LCD tend to be large scale.

In general, a typical circuit of a liquid crystal display having both reflection and transmission regions is illustrated in FIG. 1A, in which the LCD matrix display device commonly comprises a LCD display array 200 that further includes a plurality of display elements 50, whose enlarged diagram is shown in the FIG. 1B, arranged in a matrix of rows and columns. Switching devices (not shown in this figure) are coupled with display elements 50 to control the application of video signals thereto. Each display element 50 acts as a switching device that includes a pixel capacitor 106 and a maintenance capacitor 108 driven by a switching transistor 104, referring to FIG. 1B.

FIG. 1B is an enlarged schematic diagram of a circuit of a liquid crystal display having both reflection and transmission regions according to one preferred embodiment of the present invention. The switching transistor 104 is usually a thin-film transistor (TFT) that is deposited on a transparent substrate such as glass. The switching transistor 104 is deposited on the glass on the same side of the display matrix as the switching transistor and has its source/drain electrode respectively connected to the capacitor electrodes of the pixel capacitor 106 and the maintenance capacitor 108. The source/drain electrode of the switching transistor 104 is connected to a column data driver (not shown in this figure) through the video data line 100 to which video signals are applied. The gate electrodes of the switching transistor 104 is coupled to a row select driver (not shown in this figure) through a scan line 102, and a scan signal is applied to turn on the switching transistor 104.

By scanning the scan lines 102 and in accordance with the scan signals, all of the switching transistors 104 in a given scan line 102 are turned on. At the same time, video signals are provided in the video data lines synchronously with the selected scan line 102. When the switching transistors 104 in a given scan line 102 are selected by the scan signals, the video signals supplied to the switching transistors 104 charge the pixel capacitors 106 and the maintenance capacitor 108 to a voltage value corresponding to the video signal on the video data line. Thus each pixel capacitor 106 with its electrodes on opposite sides of the matrix display acts as a capacitor. When a signal for a selected scan line 102 is removed, the charge in the pixel capacitor 106 is preserved until the next repetition when that scan line is again selected by a scan signal and new voltages are stored therein. Thus a picture is displayed on the matrix display by the charges stored in the pixel capacitors 106.

However, for a liquid crystal display having both reflection and transmission regions, the pixel capacitor 106 crosses both regions. Once the switching transistor 104 or the pixel capacitor 106 is broken, the display element 50 fails.

On the other hand, the main function of the maintenance capacitor 108 is to maintain the constancy of the voltage value applied to the pixel capacitor 106. That is, before the data stored in the pixel capacitor 106 is refreshed, the voltage applied to the pixel capacitor 106 is maintained by the maintenance capacitor 108. However, with regard to the conventional liquid crystal display having both reflection and transmission regions, the pixel capacitor 106 crosses both regions; therefore, the maintenance capacitor 108 needs to simultaneously maintain the voltage applied to the reflection and transmission regions. The capacitor value of the maintenance capacitor 108 needs to be enlarged to avoid electric charge leakage which would result in a sharp decrease of the voltage applied therein. Accordingly, the enlarged capacitor value of the maintenance capacitor 108 requires a larger current to drive the refresh data process so as to finish this refresh process in the same time. However, this increases the difficulties of circuit design.

### SUMMARY OF THE INVENTION

According to the above descriptions, with regard to the conventional liquid crystal display having reflection and transmission regions, each display element 50 comprises a pixel capacitor 106 and a maintenance capacitor 108 both driven by a switching transistor 104. Therefore, once one of them is broken, the whole display element fails.

On the other hand, the pixel capacitor 106 crosses both regions. Therefore, the maintenance capacitor 108 needs to simultaneously maintain the voltage applied to the reflection and transmission regions. The capacitor value of the maintenance capacitor needs to be enlarged to avoid electric charge leakage which would result in a sharp decrease of the voltage applied therein. The enlarged capacitor value of the maintenance capacitor 108 requires a larger current to drive the refresh data process so as to finish this refresh process in the same time. This increases the difficulties of circuit design. Therefore, the present invention provides a circuit structure to solve the above problems.

The primary object of the present invention is to provide a circuit for liquid crystal displays with reduced power consumption.

Another object of the present invention is to provide a circuit for liquid crystal displays with reduced drive current in the refresh process.

A further object of the present invention is to provide a circuit for liquid crystal displays in which each display element comprises a plurality of pixel capacitors, a plurality of maintenance capacitors and a plurality of switching transistors and those capacitors and transistors are isolated from each other. Such a structure avoids failure of the entire display element when one capacitor or transistor breaks. The present invention provides a circuit for liquid crystal displays having reflection and transmission regions. In accordance with the present invention, each display element comprises a plurality of pixel capacitors, a plurality of maintenance capacitors and a plurality of switching transistors. The reflection and transmission regions respectively comprise a pixel capacitor, a maintenance capacitor and a switching transistor. Therefore, the two regions are isolated from each other. That is, a breakage in the reflection region does not affect the transmission region work, and vice versa. Furthermore, in accordance with the circuit structure of the present invention, because each maintenance capacitor only needs to maintain the voltage applied the pixel capacitor of the reflection or transmission region, the capacitor value does not require enlargement. Therefore, the charge current may be decreased.

In accordance with the structure of the present invention, a scan line is used to control two thin film transistors and a video data line is used to transmit a video signal to pixel capacitors and maintenance capacitors. When the thin film transistors are selected by the selection signal, the video signal stored therein charges the pixel capacitors and maintenance capacitors. When selection signal is removed, the charge in the pixel capacitors is preserved until the next repetition when that scan line is again selected by a selection signal and new voltages are stored therein. Thus a picture is displayed on the matrix display by the charges stored in the pixel capacitors.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram of a display circuit structure of the liquid crystal display in accordance with the conventional invention;

FIG. 1B is an enlarged schematic diagram of a display circuit structure of the liquid crystal display in accordance with the conventional invention;

FIG. 2 is a schematic diagram of a display circuit structure of the liquid crystal display in accordance with the first embodiment of the present invention; and

FIG. 3 is a schematic diagram of a display circuit structure of the liquid crystal display in accordance with the second embodiment of the present invention.

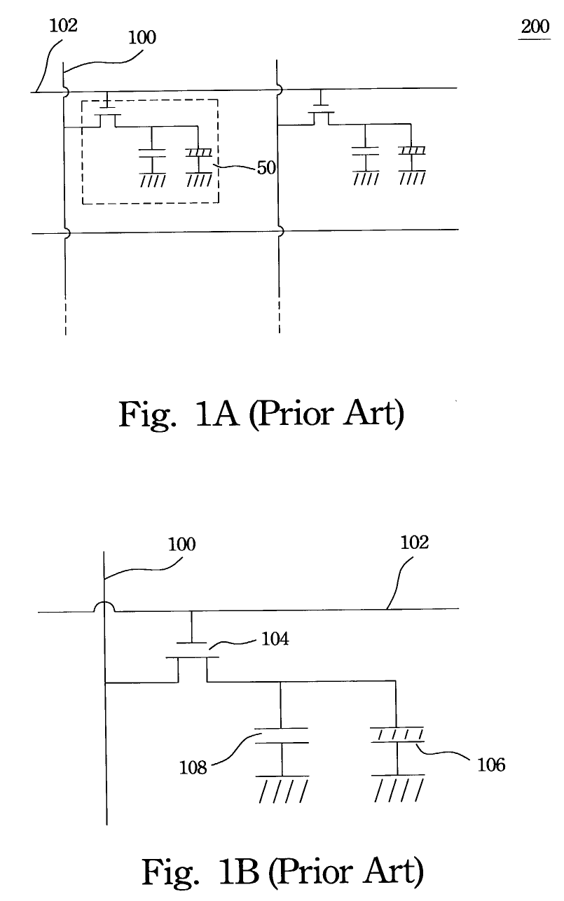

### DETAILED DESCRIPTION OF THE PREFERRED EMBODIMENT

Without limiting the spirit and scope of the present invention, the circuit structure in a liquid crystal display (LCD) proposed in the present invention is illustrated with one preferred embodiment. Skilled artisans, upon acknowledging the embodiments, can apply the circuit design of the present invention to any kind of liquid crystal display to form a display circuit structure. In accordance with the circuit structure of the present invention, the present invention avoids the drawback existing in the conventional liquid crystal display circuit structure having display elements composed only of a pixel capacitor, a maintenance capacitor and a switching transistor. However, this kind of conventional circuit structure may result in total display element failure once one of the three devices breaks. The structure of the present invention uses display elements comprising plurality of pixel capacitors, a plurality of maintenance capacitors and a plurality of switching transistors; therefore, when one , the devices can replace it to make the whole display element keep working.

On the other hand, the circuit structure of the present invention also avoids the drawback of the conventional circuit design in which only one maintenance capacitor having a larger capacitor value is used to maintain the voltage applied to the reflection and transmission region. In accordance with this conventional structure, the enlarged capacitor value of the maintenance capacitor requires a larger current to drive the refresh data process, which increases the power consumption. The application of the present invention is not limited by the following description.

The present invention provides a circuit structure for liquid crystal displays having reflection and transmission regions. In accordance with the present invention, each display element comprises a plurality of pixel capacitors, a plurality of maintenance capacitors and a plurality of switching transistors. The reflection and transmission regions respectively comprise a pixel capacitor, a maintenance capacitor and a switching transistor. Therefore, the two regions are isolated from each other. That is, breakage in the reflection region does not affect the transmission region work, and vice versa. Furthermore, in accordance with the circuit structure of the present invention, because each maintenance capacitor only needs to maintain the voltage applied the pixel capacitor of the reflection or transmission region, the capacitor value does not require enlargement. Therefore, the charge current may be decreased. The detailed description of the present invention is as follows.

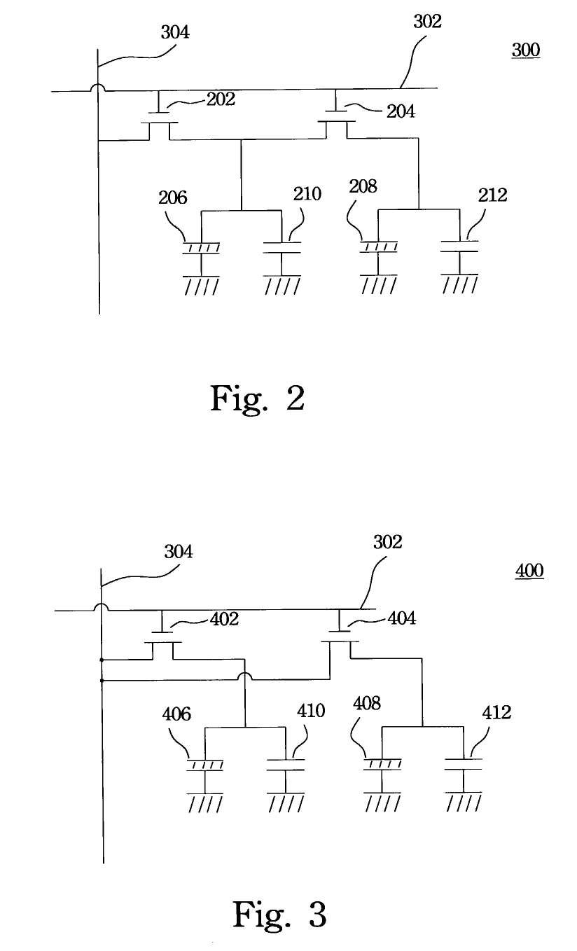

FIG. 2 is a schematic diagram of a display circuit structure 300 of a liquid crystal display in accordance with the first embodiment of the present invention. This circuit structure 300 is used in a thin film transistor liquid crystal display (TFT-LCD) having reflection and transmission regions therein. In this circuit structure, each display element comprises two pixel capacitors 206 and 208, two maintenance capacitors 210 and 212 and two switching transistors 202 and 204. The pixel capacitors 206, maintenance capacitor 210 and switching transistor 202 are used to control the reflection region in the thin film transistor liquid crystal display. The pixel capacitors 208, maintenance capacitor 212 and switching transistor 204 are used to control the transmission region in the thin film transistor liquid crystal display.

The gate electrodes of the switching transistors 202 and 204 are both coupled with a scan line 302. The scan line 302 is used to control the turning on/off of the switching transistors 202 and 204. The source/drain electrode of the switching transistors 202 is coupled with the video data line that is used to transmit the video signal. The video data line 304 and the scan line 302 work simultaneously to select a display element from a display element array (not shown in this figure). The other source/drain electrode of the switching transistor 202 is respectively coupled with the electrodes of the pixel capacitor 206 and the maintenance capacitor 210, and is also coupled with the source/drain electrode of the other switching transistor 204. The other source/drain electrode of the switching transistors 204 is respectively coupled with the electrodes of the pixel capacitor 208 and the maintenance capacitor 212.

When operation, a selection signals is transmitted to the scan line 302; that is, a high voltage is applied to the scan line 302 to turn on the switching transistors 202 and 204. At the same time, video signals are transmitted form the video data line 304 to the source/drain electrode of the switching transistor 202. Then, the video signal transmits to the pixel capacitor 206 and the maintenance capacitor 210 through the channel of the switching transistor 202, and also transmits to the pixel capacitor 208 and the maintenance capacitor 212 through the channel of the switching transistor 204. The video signals may respectively charge the pixel capacitor 206 and 208 and the maintenance capacitor 210 and 212 to the corresponding voltage value applied to the video data line to drive the liquid crystal in the reflection and transmission regions.

When the selection signals in the scan line 302 are removed and another selection signals are not transmitted to the scan line 302 yet, the switching transistors 202 and 204 are turned off. The charge still retained in the pixel capacitor 206 and 208 and the maintenance capacitor 210 and 212. Therefore, a picture is displayed on the display by the charges stored in the pixel capacitors 206 and 208.

In accordance with the structure described in the above, the reflection and transmission regions respectively comprise a pixel capacitor, a maintenance capacitor and a switching transistor. Therefore, the two regions are isolated from each other. That is, the break in the reflection region does not affect the transmission region work, and vice versa. For example, if the pixel capacitor 206 breaks, it only affects the reflection region of the circuit structure 300. The transmission region of the circuit structure 300 still works well.

Furthermore, in accordance with the circuit structure of the present invention, the voltage applied to the pixel capacitors 206 and 208 are respectively maintained by the maintenance capacitors 210 and 212. Therefore, the capacitor value does not require enlargement. The charge current can be decreased. In other words, the circuit structure of the present invention uses two pixel capacitors and maintenance capacitors to control respectively the reflection and transmission regions, which is different from the conventional structure using only one pixel capacitor and maintenance capacitor to control the reflection and transmission regions. Therefore, the electric charge leakage ratio in a constant time of the present invention structure is lower than the conventional structure. In other words, because each maintenance capacitor only needs to maintain the voltage applied the pixel capacitor in the reflection or transmission region, the capacitor value does not require enlargement. Therefore, the charge current is decreased when a refresh process is conducted.

FIG. 3 is a schematic diagram of a display circuit structure 400 of the liquid crystal display in accordance with the second embodiment of the present invention. This circuit structure 400 is also used in a thin film transistor liquid crystal display (TFT-LCD) having reflection and transmission regions therein. In this circuit structure, each display element comprises two pixel capacitors 406 and 408, two maintenance capacitors 410 and 412 and two switching transistors 402 and 404. The pixel capacitors 406, maintenance capacitor 410 and switching transistor 402 are used to control the reflection region in the thin film transistor liquid crystal display. The pixel capacitors 408, maintenance capacitor 412 and switching transistor 404 are used to control the transmission region in the thin film transistor liquid crystal display.

The gate electrodes of the switching transistors 402 and 404 are both coupled with a scan line 302. The scan line 302 is used to control the turning on/off of the switching transistors 402 and 404. The source/drain electrode of the switching transistors 402 is coupled with the video data line that is used to transmit the video signal. The video data line 304 and the scan line 302 can work simultaneously to select a display element from a display element array (not shown in this figure). The other source/drain electrode of the switching transistor 402 is respectively coupled with the electrodes of the pixel capacitor 406 and the maintenance capacitor 410. The source/drain electrode of the switching transistors 404 is respectively coupled with the electrodes of the pixel capacitor 408 and the maintenance capacitor 412, and the other source/drain electrode of the switching transistors 404 is also coupled with the video data line 304.

During operation, a selection signal is transmitted to the scan line 302; that is, a high voltage is applied to the scan line 302 to turn on the switching transistors 402 and 404. At the same time, video signals are transmitted from the video data line 304 to the source/drain electrode of the switching transistors 402 and 404. Then, the video signal is transmitted to the pixel capacitor 406 and 408 and the maintenance capacitor 410 and 412 respectively through the channel of the switching transistor 402 and 404. The video signals respectively charge the pixel capacitors 406 and 408 and the maintenance capacitor 410 and 412 to the corresponding voltage value applied to the video data line so as to drive the liquid crystal in the reflection and transmission regions.

When the selection signals in the scan line 302 are removed and another selection signal is not transmitted to the scan line 302 yet, the switching transistor 402 and 504 is turned off. The charge is still retained in the pixel capacitor 406 and 408 and the maintenance capacitor 410 and 412. Therefore, a picture is displayed on the display by the charges stored in the pixel capacitors 406 and 408.

In accordance with the structure described in the above, the reflection and transmission regions are respectively composed of a pixel capacitor, a maintenance capacitor and a switching transistor. Therefore, the two regions are isolated from each other. That is, the break in the reflection region does not affect the transmission region work, and vice versa. For example, if the pixel capacitor 406 breaks, it only affects the reflection region of the circuit structure 400. The transmission region of the circuit structure 400 still works well.

Furthermore, in accordance with the circuit structure of the present invention, the voltage applied to the pixel capacitors 406 and 408 are respectively maintained by the maintenance capacitors 410 and 412. Therefore, the capacitor value does not require enlargement. The charge current can be decreased. In other words, the circuit structure of the present invention uses two pixel capacitors and maintenance capacitors to control respectively the reflection and transmission regions, which is different from the conventional structure using only one pixel capacitor and maintenance capacitor to control the reflection and transmission regions. Therefore, the electric charge leakage ratio in a constant time of the present invention structure is lower than the conventional structure. In other words, because each maintenance capacitor only needs to maintain the voltage applied the pixel capacitor in the reflection or transmission region, the capacitor value does not require enlargement. Therefore, the charge current can be decreased when a refresh process is operated.

As is understood by a person skilled in the art, the foregoing preferred embodiments of the present invention are illustrative of the present invention rather than limiting of the present invention. They are intended to cover various modifications and similar arrangements included within the spirit and scope of the appended claims, the scope of which should be accorded the broadest interpretation so as to encompass all such modifications and similar structure.

What is claimed is:

1. A display circuit structure of the liquid crystal display having reflection and transmission regions, said circuit structure comprising:
first and second data lines;
a plurality of transistors, wherein said transistors are connected in series to couple with said first data line and a gate electrode of each transistor is coupled with said second data line; and
a plurality of capacitor pairs, wherein each capacitor pair comprises a pixel capacitor and a maintenance capacitor connected in parallel and each capacitor pair is coupled to a source/drain electrode of one corresponding transistor of said plurality of series connection transistors.

2. The circuit structure according to claim 1, wherein said second data line is used to control the turning on/off of said plurality of transistors.

3. The circuit structure according to claim 1, wherein said plurality of capacitor pairs is charged when said plurality of transistors is turned on.

4. A display circuit structure of the liquid crystal display having reflection and transmission regions, said circuit structure comprising:
a first data line;
a second data line crossing said first data line;
a first transistor, wherein a source/drain electrode is coupled with said first data line and a gate electrode of said first transistor is coupled with said second data line;
a first pixel capacitor, wherein said first pixel capacitor is coupled with said first data line through a channel of said first transistor;
a first maintenance capacitor, wherein said first maintenance capacitor is coupled with said first data line through the channel of said first transistor;
second transistor, wherein said second transistor is coupled with said first data line through the channel of said first transistor and a gate electrode of said second transistor is coupled with said second data line;
a second pixel capacitor, wherein said second pixel capacitor is coupled with said first data line through channels of said first and second transistors; and
second maintaining capacitor, wherein said second maintenance capacitor is coupled with said first data line through the channels of said first and second transistors.

5. The circuit structure according to claim 4, wherein said second data line is used to control turning on/off of said first and second transistors.

6. The circuit structure according to claim 4, wherein said first and second pixel capacitors and maintenance capacitors is charged when said first and second transistors are turned on.

7. The circuit structure according to claim 4, wherein said first transistor, first pixel capacitor and first maintenance capacitor are used to control a reflection region, and said second transistor, second pixel capacitor and second maintenance capacitor are used to control a transmission region.

8. The circuit structure according to claim 4, wherein said first transistor, first pixel capacitor and first maintenance capacitor are used to control a transmission region, and said second transistor, second pixel capacitor and second maintenance capacitor are used to control a reflection region.

9. A display circuit structure of the liquid crystal display having reflection and transmission regions, said circuit structure comprising:
first and second data lines;
a plurality of transistors, wherein a source/drain electrode of each transistor is coupled with said first data line and a gate electrode of each transistor is coupled with said second data line; and
a plurality of capacitor pairs, wherein each capacitor pair comprises a pixel capacitor and a maintenance capacitor connected in parallel and each capacitor pair is coupled to said first data line through a channel of a corresponding transistor of said plurality of transistors.

10. The circuit structure according to claim 9, wherein said second data line is used to control turning on/off of said plurality of transistors.

11. The circuit structure according to claim 9, wherein said plurality of capacitor pairs is charged when said plurality of transistors is turned on.

12. A display circuit structure of the liquid crystal display having reflection and transmission regions, said circuit structure comprising:
a first data line;
a second data line crossing said first data line;
first transistor, wherein a source/drain electrode is coupled with said first data line and a gate electrode of said first transistor is coupled with said second data line;
first pixel capacitor, wherein said first pixel capacitor is coupled with said first data line through a channel of said first transistor;
first maintenance capacitor, wherein said first maintenance capacitor is coupled with said first data line through the channel of said first transistor;
a second transistor, wherein the source/drain electrode is coupled with said first data line and the gate electrode of said first transistor is coupled with said second data line;
a second pixel capacitor, wherein said second pixel capacitor is coupled with said first data line through a channel of said second transistor; and
a second maintenance capacitor, wherein said second maintenance capacitor is coupled with said first data line through the channel of said second transistor.

13. The circuit structure according to claim 12, wherein said second data line is used to control turning on/off of said first and second transistors.

14. The circuit structure according to claim 12, wherein said first and second pixel capacitors and maintenance capacitors are charged when said first and second transistors are turned on.

15. The circuit structure according to claim 12, wherein said first transistor, first pixel capacitor and first maintenance capacitor are used to control the reflection region, and said second transistor, second pixel capacitor and second maintenance capacitor are used to control the transmission region.

16. The circuit structure according to claim 12, wherein said first transistor, first pixel capacitor and first maintenance capacitor are used to control the transmission region, and said second transistor, second pixel capacitor and second maintenance capacitor are used to control the reflection region.
